(19) United States
(12) Patent Application Publication
(10) Pub. No.: US 2013/0252643 A1
(43) Pub. Date: Sep. 26, 2013

(54) METHOD FOR TRANSMITTING AND RECEIVING IDLE-MODE PARAMETER UPDATE INFORMATION, AND APPARATUS THEREFOR

(71) Applicants: Giwon Park, Anyang-si (KR); Youngsoo Yuk, Anyang-si (KR); Jeongki Kim, Anyang-si (KR)

(72) Inventors: Giwon Park, Anyang-si (KR); Youngsoo Yuk, Anyang-si (KR); Jeongki Kim, Anyang-si (KR)

(73) Assignee: LG ELECTRONICS INC., Seoul (KR)

(21) Appl. No.: 13/992,184

(22) PCT Filed: Dec. 28, 2011
(86) PCT No.: PCT/KR2011/010207

§ 371 Date: Jun. 6, 2013

Related U.S. Application Data
(60) Provisional application No. 61/427,791, filed on Dec. 28, 2010.
(60) Provisional application No. 61/430,122, filed on Jan. 5, 2011.

(51) Int. Cl. H04W 8/24

(52) U.S. Cl. CPC H04W 8/24
USPC 455/458

(57) ABSTRACT

Disclosed is a method for transmitting and receiving idle-mode parameter update information and an apparatus therefor. A machine-to-machine (M2M) device for receiving idle-mode parameter update information in a wireless communication system comprises: a receiver for receiving, from a base station, a paging message including an M2M group identifier (ID) field indicating an M2M group ID and an action code field indicating an idle-mode parameter update; and a processor that decodes the action code field when said M2M group ID corresponds to the M2M group ID of the processor, to thereby acquire information which indicates that said paging message is a message relating to the idle mode parameter update. The paging message may further include an updated M2M group ID field indicating an updated M2M group ID, and the processor may decode the updated M2M group ID field to thereby acquire updated M2M group ID information.

### TECHNICAL FIELD

The present invention relates to wireless communication, and more particularly, to a method for transmitting and receiving idle-mode parameter update information and an apparatus therefor.

### BACKGROUND ART

Machine-to-Machine (M2M) communication refers to communication between an electronic device and another electronic device. In a broad sense, M2M communication refers to wire or wireless communication between electronic devices or communication between a machine and a device controlled by a person. However, it is general that M2M communication recently refers to wireless communication between electronic devices, i.e., devices performed without control of a person.

In the early 1990s when M2M communication has been introduced, M2M communication has been recognized as remote control or telematics and M2M communication markets have been very restrictive. However, M2M communication markets have received attention all over the world since M2M communication had been able to grow rapidly for last several years. Particularly, M2M communication has exerted its great influence at point of sales (POS) and security related application markets in the fields of fleet management, remote monitoring of machine and facilities, measurement of working time on construction machine facilities, and smart meter automatically measuring heat or the use of electricity. It is expected that M2M communication will be used for various purpose of uses in association with the existing mobile communication and low power communication solutions such as wireless high-speed Internet, Wi-Fi, and Zigbee and that its coverage will be extended to business to consumer (B2C) markets without limitation to business to business (B2B) markets.

In the M2M communication age, since all machines provided with a subscriber identity module (SIM) card may be able to perform data transmission and reception, they may remotely be controlled. For example, M2M communication technologies may be used for many machines and equipments such as cars, trucks, trains, containers, vending machines, and gas tanks. In this way, application ranges of M2M communication technologies are very broad.

According to the related art, since it was general that a mobile station was controlled separately, communication between a base station and a mobile station has been performed by a one-to-one communication mode. Supposing that many M2M devices perform communication with a base station through such a one-to-one communication mode, network overload will be caused by signaling generated between each of the M2M devices and the base station. As described above, if M2M communication is rapidly spread and widely used, a problem may occur due to overhead caused by communication between M2M devices or between each of the M2M devices and the base station.

### DISCLOSURE

### Technical Problem

An object of the present invention devised to solve the conventional problem is to provide a method for allowing a machine to machine (M2M) device to receive idle mode parameter update information in a wireless communication system.

Another object of the present invention is to provide an M2M device that receives idle mode parameter update information in a wireless communication system.

Still another object of the present invention is to provide a method for allowing a base station to transmit idle mode parameter update information.

Further still another object of the present invention is to provide a base station that transmits idle mode parameter update information.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

To solve the aforementioned technical problems, in one aspect of the present invention, a method for allowing a machine to machine (M2M) device to receive idle mode parameter update information in a wireless communication system comprises the steps of receiving a paging message including an M2M group identifier (ID) field indicating an M2M group ID and an action code field indicating an idle mode parameter update, from a base station; and decoding the action code field when the M2M group ID corresponds to M2M group ID of the M2M device, to acquire information which indicates that the paging message is a message related to the idle mode parameter update. The paging message may further include an updated M2M group ID field indicating updated M2M group ID, and the method may further comprise the step of acquiring updated M2M group ID information by decoding the updated M2M group ID field. The paging message may further include an available state timer field indicating time duration for which an updated available state is maintained, and the method may further comprise the step of acquiring information on time duration for which an updated available state is maintained, by decoding the available state timer field. The paging message may further include an unavailable state timer field indicating time duration for which an updated unavailable state is maintained, and the method may further comprise the step of acquiring information on time duration for which an updated unavailable state is maintained, by decoding the unavailable state timer field. The paging message may further include a multicast security key field indicating an updated multicast security key, and the method may further comprise the step of acquiring updated multicast security key information by decoding the multicast security key field. The paging message may further include a paging cycle field indicating an updated paging cycle, and the method may further comprise the step of acquiring information on an updated paging cycle by decoding the paging cycle field.

To solve the aforementioned technical problems, in another aspect of the present invention, a machine to machine (M2M) device for receiving idle mode parameter update information in a wireless communication system comprises a receiver receiving a paging message including an M2M group identifier (ID) field indicating an M2M group ID and an action code field indicating an idle mode parameter update, from a base station; and a processor decoding the action code field when the M2M group ID corresponds to M2M group ID of the processor, to acquire information which indicates that the paging message is a message related to the idle mode parameter update. The paging message may further include an updated M2M group ID field indicating updated M2M group ID, and the processor may acquire updated M2M group ID information by decoding the updated M2M group ID field. The paging message may further include an available state timer field indicating time duration for which an updated available state is maintained, and the processor may acquire information on time duration for which an updated available state is maintained, by decoding the available state timer field. The paging message may further include an unavailable state timer field indicating time duration for which an updated unavailable state is maintained, and the processor may acquire information on time duration for which an updated unavailable state is maintained, by decoding the unavailable state timer field. The paging message may further include a multicast security key field indicating an updated multicast security key, and the processor may acquire updated multicast security key information by decoding the multicast security key field. The paging message may further include a paging cycle field indicating an updated paging cycle, and the processor may acquire information on an updated paging cycle by decoding the paging cycle field.

To solve the aforementioned technical problems, in still another aspect of the present invention, a method for transmitting idle mode parameter update information to a machine to a machine (M2M) device in a wireless communication system comprises the step of transmitting a paging message including an M2M group identifier (ID) field indicating an M2M group ID and an action code field to the M2M device, wherein the action code indicates that the paging message is related to the idle mode parameter update. The paging message may further include at least one of an updated M2M group ID field indicating updated M2M group ID, an available state timer field indicating time duration for which an updated available state is maintained, an unavailable state timer field indicating time duration for which an updated unavailable state is maintained, and a paging cycle field indicating an updated paging cycle.

To solve the aforementioned technical problems, in further still another aspect of the present invention, a base station for transmitting idle mode parameter update information to a machine to a machine (M2M) device in a wireless communication system comprises a transmitter transmitting a paging message including an M2M group identifier (ID) field indicating an M2M group ID and an action code field to the M2M device, wherein the action code indicates that the paging message is related to the idle mode parameter update.

### Advantageous Effects

The M2M device may perform efficient communication on the basis of updated idle mode parameter information by receiving the updated idle mode parameter information through a paging message.

Also, the M2M device may efficiently perform communication by receiving various types of group paging and individual paging messages according to the present invention.

It will be appreciated by persons skilled in the art that that the effects that could be achieved with the present invention are not limited to what has been particularly described hereinabove and other advantages of the present invention will be more clearly understood from the following detailed description.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a brief diagram illustrating configurations of an M2M device and a base station according to one embodiment of the present invention;

FIG. 2 is a diagram illustrating an example of a hierarchical M2M group structure;

FIG. 3 is a diagram illustrating an example of a method for allocating group ID and sub-group ID;

FIG. 4 is a diagram illustrating an embodiment that a group paging indication field set to 1 in a paging message is transmitted;

FIG. 5 is a diagram illustrating that a group paging indication field included in a first paging message is set to 0 (that is, individual paging message transmission) in the first paging message and then an individual paging message is transmitted;

FIG. 6 is a diagram illustrating code ranging performed by M2M devices, which receives a group paging message, during network re-entry;

FIG. 7 is a diagram illustrating that an individual paging message is transmitted independently in accordance with one embodiment;

FIG. 8 is a diagram illustrating that an individual paging message is transmitted independently in accordance with another embodiment;

FIG. 9 is a diagram illustrating an example that there is no M2M device for paging in a group;

FIG. 10 is a diagram illustrating a method for allowing M2M devices, which belong to one group, to update a parameter;

FIG. 11 is a diagram illustrating that an idle mode parameter is updated through a paging message and allocated to an M2M device during idle mode entry;

FIG. 12 is a diagram illustrating an embodiment that an idle mode parameter of each of individual M2M devices is updated through a unicast MAC control message; and

FIG. 13 is a diagram illustrating that an idle mode parameter is updated in the same manner as FIG. 12 and allocated to an M2M device during idle mode entry.

### BEST MODE FOR CARRYING OUT THE INVENTION

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes detailed matters to provide full understanding of the present invention. However, it will be apparent to those skilled in the art that the present invention can be carried out without the detailed matters. For example, although the following description will be made on the assumption that a mobile communication system is a 3GPP LTE system or a 3GPP LTE-A system, the following description may be applied to other random mobile communication systems except matters specific to the 3GPP LTE or the 3GPP LTE-A.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

Moreover, in the following description, it is assumed that a mobile station refers to a mobile or fixed type user terminal device such as a user equipment (UE) and an advanced mobile station (AMS). Also, it is assumed that a base station refers to a random node of a network terminal, which performs communication with a mobile station, such as Node B (NB), eNode B, and an access point (AP). In this specification, although the description of the present invention will be made based on the IEEE 802.16 system, the description may be applied to other various communication systems.

In a mobile communication system, a mobile station may receive information from a base station through a downlink (DL), and may also transmit information to the base station through an uplink. Examples of information transmitted from and received by the mobile station include data and various kinds of control information. Various physical channels exist depending on types and usage of information transmitted from or received by the mobile station.

The following technology may be used for various wireless access systems such as CDMA (code division multiple access), FDMA (frequency division multiple access), TDMA (time division multiple access), OFDMA (orthogonal frequency division multiple access), and SC-FDMA (single carrier frequency division multiple access). The CDMA may be implemented by the radio technology such as universal terrestrial radio access (UTRA) or CDMA2000. The TDMA may be implemented by the radio technology such as global system for mobile communications (GSM)/general packet radio service (GPRS)/enhanced data rates for GSM evolution (EDGE). The OFDMA may be implemented by the radio technology such as IEEE 802.11 (Wi-Fi), IEEE 802.16 (WiMAX), IEEE 802.20, and evolved UTRA (E-UTRA). The UTRA is a part of a universal mobile telecommunications system (UMTS). A 3^{rd} generation partnership project long term evolution (3GPP LTE) communication system is a part of an evolved UMTS (E-UMTS) that uses E-UTRA, and uses OFDMA in a downlink while uses SC-FDMA in an uplink. LTE-advanced (LTE-A) is an evolved version of the 3GPP LTE system. The LTE-A is an evolved version of the 3GPP LTE.

Also, specific terminologies hereinafter used in the embodiments of the present invention are provided to assist understanding of the present invention, and various modifications may be made in the specific terminologies within the range that they do not depart from technical spirits of the present invention.

Hereinafter, communication between M2M devices means information exchange performed between mobile stations through a base station, or between a base station and mobile stations without control of a user. Accordingly, the M2M device means a mobile station that can support communication of the M2M device. An access service network for M2M service will be defined as an M2M access service network (ASN), and a network entity that performs communication with M2M devices will be referred to as M2M server. The M2M server performs M2M application, and provides M2M specific service for one or more M2M devices. M2M feature is a feature of M2M application, and one or more features may be required to provide application. M2M device group means a group of M2M devices that share one or more features.

Devices (that may be referred to as various terms such as M2M device, M2M communication device, and machine type communication (MTC) device) that perform communication in M2M mode will be increased gradually in a certain network as their device application types are increased. Examples of device application types include (1) security, (2) public safety, (3) tracking and tracing, (4) payment, (5) healthcare, (6) remote maintenance and control, (7) metering, (8) consumer device, (9) fleet management at POS (Point Of Sales) and security related application market, (10) communication between devices of vending machines, (11) remote controlling of machine and facilities, measurement of working time on construction machine facilities, and smart meter automatically measuring heat or the use of electricity, and (12) surveillance video communication of a surveillance camera. However, the device application types are not limited to the above examples, and the other various device application types may be used.

Hereinafter, the embodiment of the present invention will be described based on M2M communication applied to a wireless communication system (for example, IEEE 802.16e/m). However, M2M communication of the present invention is not limited to the above wireless communication, and may be applied to other communication systems such as 3GPP LTE system.

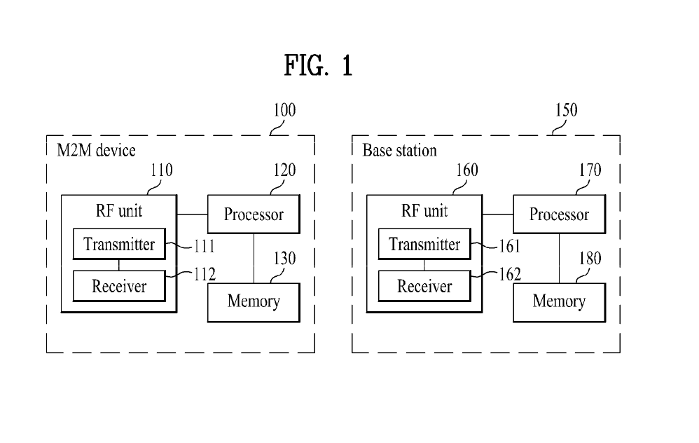

FIG. 1 is a brief diagram illustrating configurations of an M2M device and a base station according to the embodiment of the present invention.

In FIG. 1, each of an M2M device 100 (or M2M communication device) and a base station 150 may include a radio frequency (RF) unit 110, 160, and a processor 120, 170. Each of the M2M device and the base station may selectively include a memory 130, 180. Each RF unit 110, 160 may include a transmitter 111, 161 and a receiver 112, 162. In case of the M2M device 100, the transmitter 111 and the receiver 112 may be configured to transmit and receive a signal to and from the base station 150 and other M2M devices, and the processor 120 may be functionally connected with the transmitter 111 and the receiver 112 to control the signal transmission and reception procedure of the transmitter 111 and the receiver 112 to and from other devices. Also, the processor 120 performs various kinds of processing for a signal for transmission and then transmits the processed signal to the transmitter 111, and may perform processing for the signal received by the receiver 112. The processor 120 may store information included in the exchanged message in the memory 130 if necessary. The M2M device 100 configured as above may perform methods of various embodiments which will be described later. In the meantime, although not shown in FIG. 1, the M2M device 100 may include various additional elements in accordance with its device application type. If the corresponding M2M device 100 is for smart metering, it may include additional element for power measurement. An operation for power measurement may be controlled by the processor 120 shown in FIG. 1, or may be controlled by a separate processor (not shown).

Although FIG. 1 illustrates an example of communication performed between the M2M device 100 and the base station 150, a method for M2M communication according to the present invention may be performed between the M2M devices, each of which may perform the method according to various embodiments, which will be described later, in the same manner as each device shown in FIG. 1.

In case of the base station 150, the transmitter 161 and the receiver 162 may be configured to transmit and receive a signal to and from another base station, M2M server and M2M devices, and the processor 170 may be functionally connected with the transmitter 161 and the receiver 162 to control the signal transmission and reception procedure of the transmitter 161 and the receiver 162 to and from other devices. Also, the processor 170 performs various kinds of processing for a signal for transmission and then transmits the processed signal to the transmitter 161, and may perform processing for the signal received by the receiver 162. The processor 170 may store information included in the exchanged message in the memory 180 if necessary. The base station 150 configured as above may perform methods of various embodiments which will be described later.

Each processor 120, 170 of the M2M device 110 and the base station 150 indicates (for example, controls, coordinates or manages) the operation of each of the M2M device 110 and the base station 150. Each processor 120, 170 may be connected with the memory 130, 180 that stores program codes and data therein. The memory 130, 180 is connected with the processor 120, 170 and stores an operating system, an application, and general files therein.

The processor 120, 170 may be referred to as a controller, a microcontroller, a microprocessor, or a microcomputer. In the meantime, the processor 120, 170 may be implemented by hardware, firmware, software, or their combination. If the embodiments of the present invention are implemented by hardware, the processor 120, 170 may include application specific integrated circuits (ASICs), digital signal processors (DSPs), digital signal processing devices (DSPDs), programmable logic devices (PLDs), and field programmable gate arrays (FPGAs).

In the mean time, if the embodiments of the present invention are implemented by firmware or software, the firmware or software may be configured to include a module, a procedure, or a function, which performs functions or operations of the present invention. The firmware or software may be provided in the processor 120, 170 or may be stored in the memory 130, 180 and then may be driven by the processor 120, 170.

Hereinafter, an idle mode is a mode that manages paging offset, a paging cycle and a paging group approved by the base station through signaling between the mobile station and the base station to save the power of the mobile station. In other words, the idle mode is a mechanism that may allow the mobile station to periodically receive a downlink broadcast message without registration with a specific base station even though the mobile station roams a radio link environment where a plurality of base stations exist, through a wide zone.

The idle mode is the state that all normal operations as well as handover (HO) are stopped and downlink synchronization is only maintained to receive a paging message, which is a broadcast message, for a given period only. The paging message is the message that indicates paging action to the mobile station. For example, examples of the paging action include ranging and network reentry.

The idle mode may be initiated by the mobile station or the base station. In other words, the mobile station may enter the idle mode by transmitting a deregistration request (DREG-REQ) message to the base station and receiving a deregistration response (DREG-RSP) message from the base station in response to the deregistration request message. Also, the base station may enter the idle mode by transmitting an unsolicited deregistration response (DREG-RSP) message or a deregistration command (DREG-CMD) message to the mobile station.

If the mobile station receives a paging message corresponding thereto for an available interval (AI) in the idle mode, it transmits and receives data to and from the base station by switching to a connected mode through a network entry procedure.

An operation of the idle state or the idle mode generally refers to an operation for enabling downlink (DL) broadcast traffic transmission to be periodically performed although the mobile station is not registered with a specific base station, when the mobile station is moved in a radio link environment of multiple base stations. If the mobile station does not receive traffic from the base station for a predetermined time, it may be shifted to the idle mode for power saving. The mobile station which has shifted to the idle mode may receive a broadcast message (for example, a paging message) transmitted by the base station for an available interval and determine whether the mobile station shifts to a normal mode or remains in the idle mode.

The idle mode may eliminate demands for activation associated with handover and demands for a general operation so as to provide benefits to the mobile station. The idle mode may restrict the activity of the mobile station to be scanned in a discrete period so as to reduce power consumption and operational resources used by the mobile station. In addition, the idle mode may provide a simple appropriate scheme for informing the mobile station of pending downlink traffic, and may eliminate radio interface and network handover (HO) traffic from an inactive mobile station so as to provide benefits to the network and the base station.

Paging refers to a function for recognizing the location (for example, any base station or any mobile switching center) of a corresponding mobile station when an incoming signal occurs in mobile communication. A plurality of base stations for supporting the idle state or the idle mode may belong to a specific paging group so as to configure a paging zone. At this time, the paging group represents a logical group. The paging group is intended to provide a downlink with a neighboring zone that can be paged, if there is any traffic decided to target the mobile station. Preferably, the paging group fulfils a condition that a specific mobile station should be great enough to exist for most of time within the same paging group and paging load should be small enough to maintain a proper level.

The paging group may include one or more base stations. Also, one base station may be included in one or more paging groups. The paging group is defined by a management system. The paging group may use a paging group-action backbone network message. Also, a paging controller may manage a list of mobile stations, which are in an idle state, by using a paging announcement message which is one of backbone network messages, and may manage initial paging of all base stations that belong to the paging group.

For convenience of description, paging at the idle mode will be described based on the IEEE 802.16 system. However, technical spirits of the present invention are not limited to the IEEE 802.16 system. The mobile station transmits a deregistration request (DREG-REQ) message to the base station to enter the idle mode and request deregistration with the base station. Afterwards, the base station transmits a deregistration response (DREG-RSP) message to the mobile station in response to the deregistration request (DREG-REQ) message. At this time, the deregistration response (DREG-RSP) message includes paging information. In this case, entry of the mobile station to the idle mode may be initiated in accordance with a request of the base station. In this case, the base station transmits the deregistration response (DREG-RSP) message to the mobile station.

The paging information may include a paging cycle, paging offset, paging group identifier (PGID), and paging listening interval.

The mobile station that has received the deregistration response (DREG-RSP) message from the base station enters the idle mode by referring to the paging information. The idle mode has a paging cycle that may include an available interval and an unavailable interval. At this time, the available interval is the same as the paging listening interval or the paging interval. The paging offset means the time (for example, frame or subframe) when the paging interval starts within the paging cycle. Also, the paging group identifier represents an identifier of a paging group allocated to the mobile station. Also, the paging information may include paging message offset information. In this case, the paging message offset information represents the time when the paging message is transmitted from the base station. Afterwards, the mobile station may receive a paging message for the available interval, that is, the paging listening interval by using the paging information. In this case, the paging message may be transmitted through the base station or the paging controller. In other words, the mobile station monitors a radio channel in accordance with the paging cycle to receive the paging message.

The mobile station in the idle mode identifies whether there are downlink (DL) data transferred thereto by receiving the paging message for the paging listening interval. If there are downlink data (i.e., positive indication), the mobile station performs a network reentry procedure including a ranging procedure. Afterwards, the mobile station performs a connection setup procedure of a downlink service flow through a dynamic service addition (DSA) procedure. After the connection of the service flow is set up, the base station transmits downlink data of the corresponding service to the mobile station.

Hereinafter, for convenience of description, the description of the present invention will be made based on the IEEE 802.16e, 16m and 16p systems. However, technical spirits of the present invention are not limited to the IEEE 802.16e, 16m and 16p systems.

The mobile station transmits a deregistration request (DREG-REQ) message to the base station to enter the idle mode and request deregistration with the base station. Afterwards, the base station transmits a deregistration response (DREG-RSP) message to the mobile station in response to the deregistration request (DREG-REQ) message. At this time, the deregistration response (DREG-RSP) message includes paging information. In this case, entry of the mobile station to the idle mode may be initiated in accordance with a request of the base station. In this case, the base station transmits the deregistration response (DREG-RSP) message to the mobile station.

The paging information may include a paging cycle, paging offset, paging group identifier (PGID), and paging listening interval. The mobile station that has received the deregistration response (DREG-RSP) message from the base station enters the idle mode by referring to the paging information.

The idle mode has a paging cycle that may include an available interval and an unavailable interval. At this time, the available interval is the same as the paging listening interval or the paging interval. The paging offset means the time (for example, frame or subframe) when the paging interval starts within the paging cycle. Also, the paging group identifier represents an identifier of a paging group allocated to the mobile station. Also, the paging information may include paging message offset information. In this case, the paging message offset information represents the time when the paging message is transmitted from the base station.

Afterwards, the mobile station may receive a paging message for the available interval, that is, the paging listening interval by using the paging information. In this case, the paging message may be transmitted through the base station or the paging controller. In other words, the mobile station monitors a radio channel in accordance with the paging cycle to receive the paging message.

Hereinafter, a hierarchical group structure of M2M devices in the M2M communication system will be described.

M2M devices having same attributes (or characteristics or features) may be grouped to easily manage the M2M devices (or mobile stations) that belong to the same group. At this time, various references for grouping the mobile stations may be provided as follows.
Application type based grouping: grouping is performed per application type such as electronics metering, gas metering, and healthcare. For example, gas metering application types are grouped.
M2M subscriber based grouping: grouping is performed per subscriber. For example, respective M2M subscribers such as Korea Electric Power Corporation, Samchully Gas Co., Ltd., and Seoul City Gas, may be grouped.

One or more subscribers may exist in one application type. For example, in case of the gas metering application type, Samchully Gas Co., Ltd. and Seoul City Gas may exist.
Location based grouping: M2M devices may be grouped based on location.

In accordance with the aforementioned references, the M2M system may form groups and allocate group ID to each group. One group may have sub-groups as the case may be, and the base station may allocate IDs for the group and sub-groups to the M2M device.

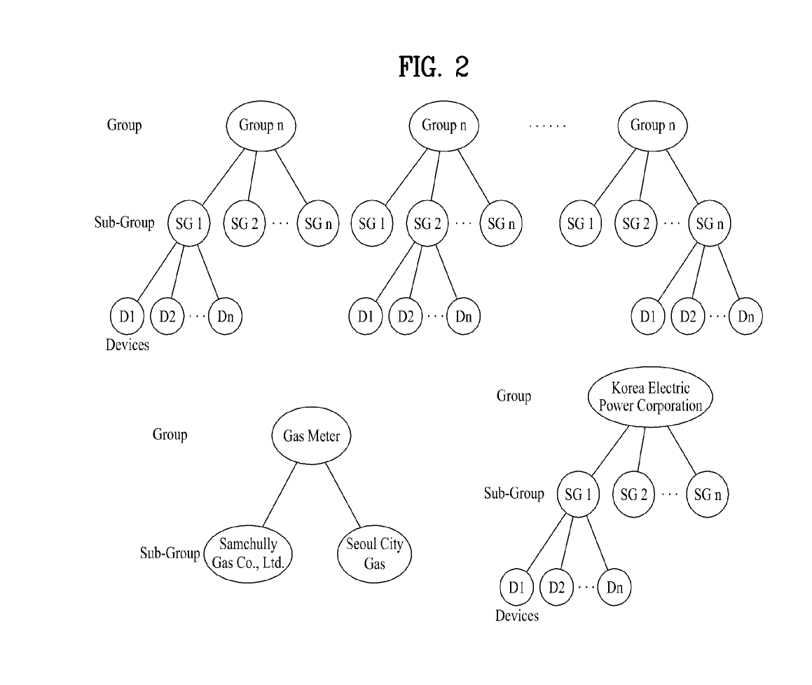

FIG. 2 is a diagram illustrating an example of a hierarchical M2M group structure.

Referring to FIG. 2, one group includes one or more sub-groups (n number of sub-groups, n=1, . . . n) each of which includes one or more M2M devices. An example of sub-grouping is as follows. Supposing that the gas metering application type is regarded as one group as described above, Samchully Gas Co., Ltd. and Seoul City Gas may be the sub-groups. If Samchully Gas Co., Ltd. which is the M2M subscriber is regarded as one group, if there are many M2M devices that belong to the group, the group may be divided into several sub-groups, each of which includes n number of M2M devices.

For example, when 1000 M2M devices belonging to Korea Electric Power Corporation exist in one cell, if one sub-group includes 100 M2M devices, 100 sub-groups may be formed for one group of Korea Electric Power Corporation. If grouping is performed for features of M2M subscriber or application type, group ID of a specific cell or network common ID is allocated. In other words, this group ID is maintained even if the cell is changed.

However, if grouping is performed for the number of M2M devices located in the cell, sub-group ID may be changed per cell, and if the cell is changed, sub-group ID needs to be updated. This may be summed up as follows.

Group ID: is network common ID, and is equally provided in the network or specific cell group.

Sub-group ID: is cell specific ID. That is, sub-group ID mapped into group ID may be varied even though group ID is equally provided per cell. If the cell is changed due to mobility, sub-group ID may be changed. In this case, the sub-group ID needs to be updated.

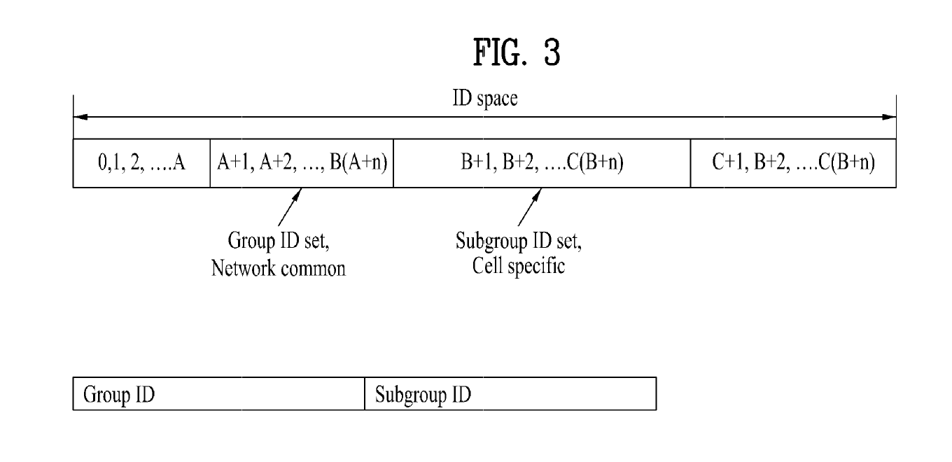

FIG. 3 is a diagram illustrating an example of a method for allocating group ID and sub-group ID.

Referring to FIG. 3, 0, 1, 2, . . . , A may be used as IDs for the existing mobile stations. A+1 to A+n(B) are group ID sets for the M2M devices and are used as group IDs which are common for the network (or specific cell group). Sub-group ID sets are B+1 to B+n(C), and may be ranged differently per cell.

If each group is divided into 10 sub-groups in the base station A, ID may be configured as illustrated in Table 1 below.

TABLE 1

| Group ID | Subgroup ID |
|---|---|
| A + 1 | B + 1, B + 2, . . . , B + 10 |
| A + 2 | B + 11, B + 12, . . . , B + 20 |
| . . . | . . . |
| A + n | B + ((10 * (n − 1)) + 1), B + ((10 * (n − 1)) + 2), |
| | B + ((10 * (n − 1)) + 10) |

IDs of sub-groups of each group may not be contiguous. For example, sub-group ID of A+1 group may be B+1, B+7, B+15, . . . .

The base station may allocate resources to the M2M device by using group ID and sub-group ID. For example, the base station uses sub-group ID (for example, M2M devices may detect MAP of a group belonging thereto by masking sub-group ID with CRC) when individually allocating resources to M2M devices of a connected mode by using individual MP IE (used when a resource is allocated to a specific M2M device only) or group allocation MAP IE (used when a resource is allocated to mobile stations belonging to group or sub-group).

However, if the base station transmits multicast traffic, such as software/firmware update, to be transmitted to all the M2M devices to which a specific M2M subscriber belongs, group ID may be used. This group ID may be used even in the case that downlink control information (for example, A-MAP IE) on the paging message is decoded (group ID is masked with CRC).

The aforementioned description may be summed up as follows. ID given by the network is Static ID.
Subscriber ID (or Multicast Group ID): ID given by the network
Network common
Used for multicast traffic transmission (included in MAP for multicast traffic (for example, CRC masking or field in MAP)
Group indication during group paging (CRC masking of MAP for paging message or included as group ID field (or bitmap) in paging message)
allocated during initial network entry (or launching), and maintained even in the idle mode. As another method, subscriber ID may be allocated through a service generating procedure (DSA procedure) for multicast service. At this time, the base station may allocate subscriber ID to the M2M device through a pre-provisional DSA procedure after the M2M device performs initial network entry.
Base station ID: unique in subscriber
included in message or MAP and indicates an individual device
User ID identify M2M device in one group of connected mode
allocated or released together with group ID when group ID is allocated or released
Group-wise Unique ID
Bitmap or ID may be inserted into MAP

The base station may transmit a group paging message or individual paging message to the M2M devices as described above. To this end, a method for including a group identifier and an individual identifier in the paging message at the same time may be considered. The M2M devices may be grouped through the aforementioned group and the M2M devices belonging to the same group may be paged. The following Table 2 illustrates an example of the paging message according to the present invention, illustrating that a group identifier and an individual identifier are included in the paging message at the same time.

TABLE 2

| | Size | | |
|---|---|---|---|
| Fields | (bits) | Value/Description | Condition |
| . . . | | | |
| M2M Group (or | | Subscriber ID to which | |
| subscriber) | | M2M device belongs | |
| Multicast ID | | | |
| Group paging | | 0 = indicates that individual | |
| indication | | M2M devices belonging to | |
| | | group are paged If Group | |
| | | paging indication is set | |
| | | to 0, individual M2M | |
| | | devices are paged to | |
| | | their individual identifier | |
| | | (e.g., DID or MAC address | |
| | | or MAC address hash). | |
| | | 1 = indicates that all M2M | |
| | | devices belonging to | |
| | | group are paged | |
| | | 2 = indicates that all M2M | |
| | | devices belonging to | |
| | | group are not paged | |
| If (Group paging | | | |
| indication == 0) | | | |
| { | | | |
| Individual paging | | Frame or subframe to which | |
| offset | | individual paging message of | |
| | | M2M device is transmitted | |
| } | | | |
| If (Group paging | | | |
| indication == 1) | | | |
| { | | | |
| // if (Group paging | | | |
| indication == 2) | | | |
| {parameters are not | | | |
| required as there is no | | | |
| M2M device paged}// | | | |

Referring to Table 2, the paging message may include an M2M group (or subscriber) multicast ID field (or parameter) and a group paging indication field. In this case, the M2M group (or subscriber) multicast ID may be abbreviated as M2M group ID. The M2M group ID field represents ID of the corresponding M2M group. The group paging indication field may be added to the paging message to support group paging and individual paging of the M2M devices within the same group. For example, if the group paging indication value is set to 0, the paging message may further include a Num_M2M_Devices field, a Deregistration Identifier or MAC address hash of M2M device field, and an Action code field. The Num_M2M_Devices field indicates the number of M2M devices paged for the corresponding M2M group, and the Deregistration Identifier or MAC address hash of M2M device field is used to indicate ID for the M2M device which will be paged. The Action code field may be used to indicate the purpose of the paging message (AAI_PAG-ADV message).

If the group paging indication value is set to 0, it supports to page some of the mobile stations which belong to the same group. In other words, individual paging including device identifier paged within the same group is supported. Accordingly, the processor 120 of the M2M device may note that the paging message pages the individual M2M devices belonging to the group if the group paging indication value is set to 0.

By contrast, if the group paging indication value is set to 1, it supports to page all the mobile stations which belong to the group in the network. At this time, the base station may reduce the size of the paging message by allowing the identifier of the paged mobile station not to be included in the paging message (M2M group multicast ID or subscriber ID is only included in the paging message). If the group paging indication value is set to 1, the processor 120 of the M2M device may note that all the M2M devices of the group to which the processor belongs are paged.

In the meantime, if the paging group indication value is set to 2, it may indicate that all the M2M devices belonging to the group are not paged. Accordingly, if the paging group indication value is set to 2, the processor 120 of the M2M device may note that it is not paged together with all the M2M devices belonging to the group to which the processor belongs.

In the paging message format of Table 2 as above, group paging and individual paging are included in one paging message. Hereinafter, unlike Table 2, a method for allowing a group identifier and an individual identifier are included in their respective paging messages different from each other will be suggested. In the present invention, a method for respectively defining group paging and individual paging in a paging message and independently transmitting a group paging message and an individual paging message will be suggested. The following Table 3 illustrates an example of a group paging message.

TABLE 3

| | Size | | |
|---|---|---|---|
| Fields | (bits) | Value/Description | Condition |
| . . . | | | |
| M2M Group (or | | Subscriber ID to which M2M | |
| subscriber) | | device belongs | |
| Multicast ID | | | |
| Group paging | | 0 = indicates that individual | |
| indication | | M2M devices belonging to | |
| | | group are paged If Group | |
| | | paging indication is | |
| | | set to 0, individual M2M | |
| | | devices are paged to | |
| | | their individual identifier | |
| | | (e.g., DID or MAC address | |
| | | or MAC address hash). | |
| | | 1 = indicates that all M2M | |
| | | devices belonging to | |
| | | group are paged | |
| | | 2 = indicates that all M2M | |
| | | devices belonging to | |
| | | group are not paged | |
| If (Group paging | | | |
| indication == 0) | | | |
| { | | | |
| M | | Value used by M2M device to | |
| | | determine paging frame | |
| | | (or cycle) for receiving | |
| | | individual paging message. | |
| | | Mobile station receives | |
| | | individual paging message | |
| | | from frame (or cycle) | |
| | | obtained by modulo operation | |
| | | of M for its device ID. | |
| | | Reference) In paging frame, | |
| | | a transfer unit of individual | |
| | | paging message is frame. | |
| | | In paging cycle, a transfer unit | |
| | | of individual paging message | |
| | | is superframe. | |
| } | | | |
| If (Group paging | | | |
| indication == 1) | | | |
| { | | | |
| // if (Group paging | | | |
| indication == 2) | | | |
| {parameters are not | | | |
| required as there is no | | | |
| M2M device paged}// | | | |

Referring to Table 3, the base station may page all the M2M devices within the group by allowing group ID to which the M2M device belongs, to be included in the paging message. At this time, the group paging indication field is set to 1.

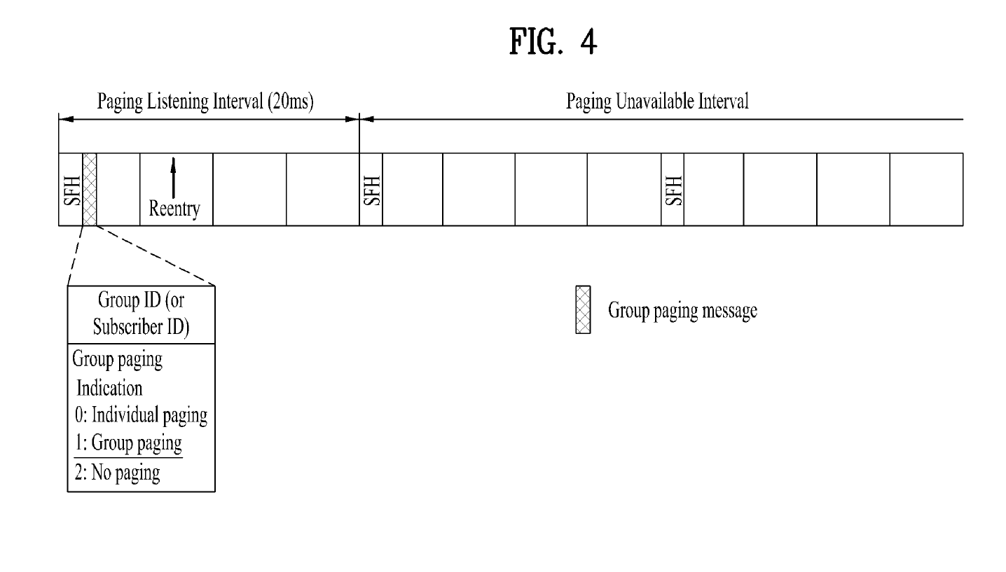

FIG. 4 is a diagram illustrating an embodiment that a group paging indication field set to 1 in a paging message is transmitted.

Referring to FIG. 4, the base station may transmit the paging message, which includes the group paging indication field, to the M2M devices for the first frame of the paging listening interval of the M2M device or the first subframe of the first frame (that is, immediately after paging ID (PGID) information message transmission frame or super frame header (SFH). As shown in FIG. 4, in case of group paging (in the case that the group paging indication field is set to 1), the individual paging message (paging message that includes an individual M2M device identifier) is not transferred, and the M2M device that has received the group paging message performs network reentry.

By contrast, if the group paging indication field is set to 0 in Table 3, the base station transmits the individual paging message to the individual M2M devices which are paged. The base station may transmit the individual paging message to the M2M devices for different frames or superframes to distribute paging load. If the group paging indication field is set to 0, the processor 120 of the M2M device may note that the base station transmits the individual paging message again.

The paging message further includes M field which is the field related to the time when the individual paging message is transmitted, if the group paging indication field is set to 0. The processor 120 of the M2M device may acquire the timing when the individual paging message corresponding thereto is transmitted from the base station, by decoding the M field. In this case, M is the value used by the M2M device to determine a paging frame (or cycle) for receiving the individual paging message. The M2M device may identify the transmission timing (frame or cycle) of the individual paging message corresponding thereto by performing modulo operation of M for its M2M device ID (for example, deregistration ID (DID)), and may receive the individual paging message at the corresponding transmission timing (frame or cycle). In this case, in the paging frame, a transfer unit of the individual paging message may be the frame, and in the paging cycle, a transfer unit of the individual paging message may be the superframe.

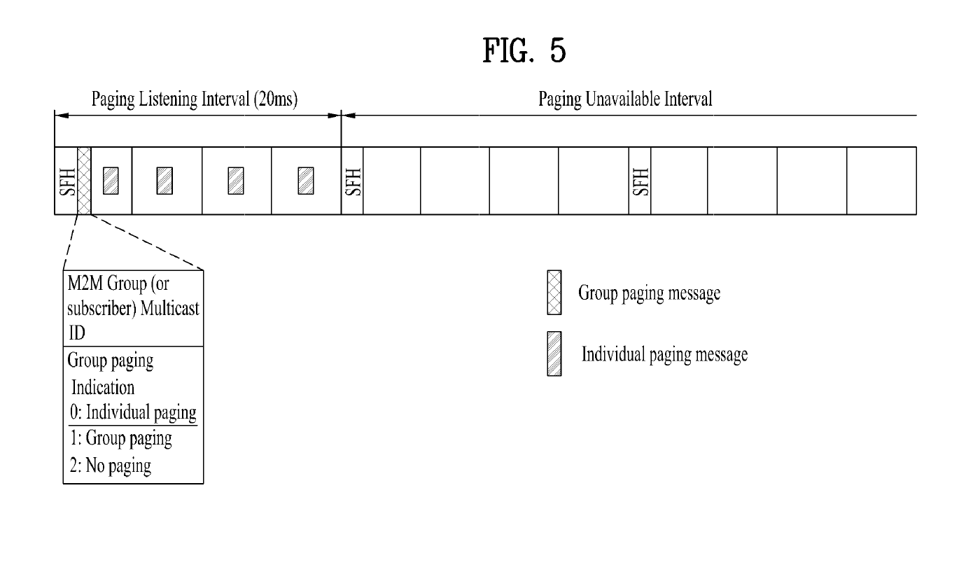

FIG. 5 is a diagram illustrating that a group paging indication field included in a first paging message is set to 0 (that is, individual paging message transmission) in the first paging message and then an individual paging message is transmitted.

Referring to FIG. 5, if the group paging indication field is set to 0 in the first paging message, it indicates that the base station transmits the individual paging message. In Table 3, if the group paging indication field is set to 0, the base station may transmit the individual paging message, which includes an individual M2M device identifier as illustrated in Table 4 below, to the M2M devices for the paging listening interval of the M2M device.

TABLE 4

| | Size | | |
|---|---|---|---|
| Fields | (bits) | Value/Description | Condition |
| . . . | | | |
| M2M Group (or | | Subscriber ID to which M2M | |
| subscriber) | | device belongs | |
| Multicast ID | | | |
| Num_devices_ID | | | |
| For (i=0; | | | |
| i<Num_devices_ID; | | | |
| i++) { | | | |
| Device ID | | | |

The processor 120 of the M2M device decodes the M field in Table 3, and receives the individual paging message illustrated in Table 4 at the corresponding time by performing “M2M device ID (or device ID) modulo M” value operation. At this time, if the M2M device identifier included in the individual paging message of Table 4 corresponds to the processor 120 of the M2M device, the processor 120 decodes the individual paging message received from the base station.

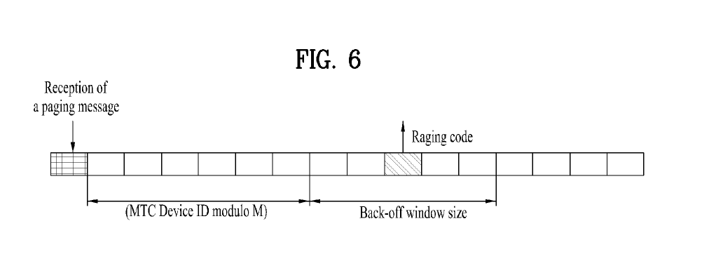

FIG. 6 is a diagram illustrating code ranging performed by M2M devices, which receives a group paging message, during network re-entry.

Referring to FIG. 6, if the M2M device receives the paging message at a specific timing, the processor 120 of the M2M device may calculate a standby time until a random access procedure is performed (back-off start time). A calculation equation for obtaining the standby time from the paging receiving time to the back-off start time may be expressed by the following Equation 1.

M2M device ID modulo M=standby time until a random access procedure is performed (back-off start time) after paging reception [Equation 1]

In this case, the M2M device ID may be the value (for example, deregistration identifier (DID) allocated from the base station to identify the M2M device in the idle mode, or may be the MAC address value or MAC address hash value, which is dedicated for the M2M device.

In this case, the M value is the value allocated to the M2M device through a capability negotiation procedure (for example, capability negotiation through AA-SBC-REQ/RSP message exchange between the base station and the M2M device), a network registration procedure (for example, registration procedure), an idle mode starting procedure (for example, AAI-DREG-REQ/RSP message exchange between the base station and the M2M device), or the paging message. the M value may be allocated from the network to the M2M device by considering attributes of subscribers to which the M2M device belongs, and the number of devices of a group (for example, M2M service or subscriber group) to which the M2M device belongs.

For example, if the modulo operation value is 3 (range of 0 to 3) as shown in FIG. 6, the M2M device applies back-off window after 3 frame from next frame for which the paging message is received. The processor 120 of the M2M device is on standby until the random access procedure is performed by modulo operation and applies back-off window (back-off window value in S-SFH SP IE3, maximum time on standby until the M2M device transmits a random access code after a random access standby time ends is used as back-off window size), and may randomly transmit a ranging code within the back-off window. As a result, even though the plurality of M2M devices receive the paging message at the same time and perform network reentry, collision may be avoided during random access through distribution of ranging code transmission. The operation value of the M2M device ID modulo M may be the subframe unit.

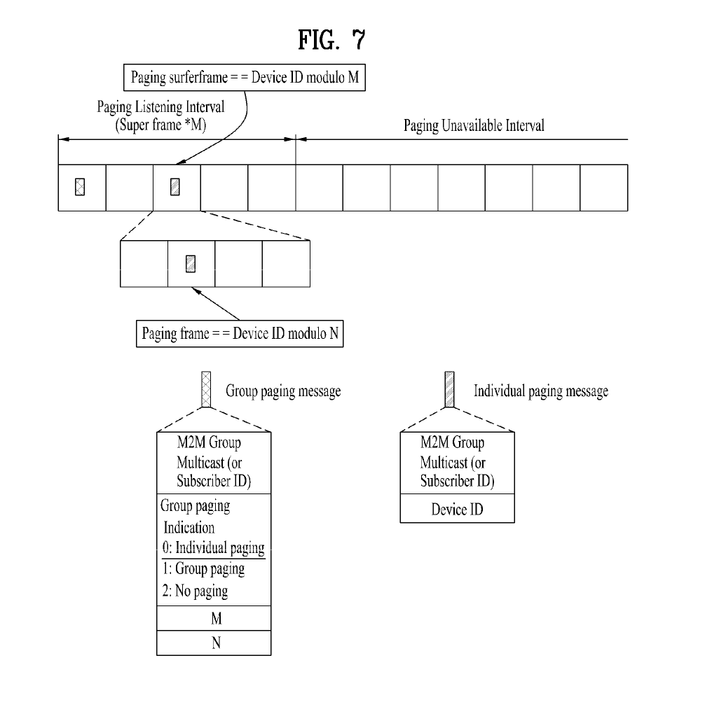

FIG. 7 is a diagram illustrating that an individual paging message is transmitted independently in accordance with one embodiment.

Referring to FIG. 7, the length of the paging listening interval of the M2M device may be defined as M X superframe. The M value is determined by the network (or base station) in accordance with the number of M2M devices belonging to the group or the amount of downlink traffic to be transmitted to the M2M device, and may be included in the group paging message of Table 5 below, which includes the group paging indication field, as M field.

TABLE 5

| | Size | | |
|---|---|---|---|
| Fields | (bits) | Value/Description | Condition |
| . . . | | | |
| M2M Group (or | | Subscriber ID to which M2M device | |
| subscriber) | | belongs | |
| Multicast ID | | | |
| Group paging | | 0 = indicates that individual M2M | |
| indication | | devices belonging to group are paged | |
| | | If Group paging indication is set to 0, | |
| | | individual M2M devices are paged to | |
| | | their individual identifier (e.g., DID or | |
| | | MAC address or MAC address hash). | |
| | | 1 = indicates that all M2M devices | |
| | | belonging to group are paged | |
| | | 2 = indicates that all M2M devices | |
| | | belonging to group are not paged | |
| If (Group paging | | | |
| indication == 0) | | | |
| { | | | |
| M | | Value used to determine paging | |
| | | listening interval length of M2M | |
| | | device. | |
| | | That is, paging listening interval of | |
| | | M2M device is as follows. | |
| | | Paging listening interval = M x | |
| | | superframe” | |
| | | Also, paging superframe monitored by | |
| | | M2M device is determined by modulo | |
| | | operation as follows. | |
| | | M2M device ID modulo M” | |
| | | M value is also used to determine a | |
| | | standby time until random access | |
| | | procedure of M2M device is performed | |
| | | during uplink code ranging performed | |
| | | when M2M device performs network | |
| | | reentry by receiving paging message | |
| | | (see FIG. 6). | |
| N | | Value used by M2M device to | |
| | | determine paging frame for receiving | |
| | | individual paging message. | |
| | | M2M device receives individual | |
| | | paging message from frame obtained | |
| | | by performing M2M device ID modulo | |
| | | N which is modulo operation of N, for its | |
| | | device ID. | |
| } | | | |
| If (Group paging | | | |
| indication == 1) | | | |
| { | | | |
| // if (Group paging | | | |
| indication == 2) | | | |
| {parameters are not | | | |
| required as there is no | | | |
| M2M device paged}// | | | |

For example, if firmware of the M2M device, among M2M applications, is upgraded, the M2M device may receive downlink multicast traffic without performing network reentry by receiving the paging message. At this time, in case of firmware upgrade, a problem may occur in that all the downlink traffics for firmware upgrade cannot be received within the existing paging listening interval (20 ms). This is because that the idle mode is not shifted to the normal mode by network reentry and the paging listening interval is 20 ms.

If all the downlink traffics within the paging listening interval are not received, the paging listening interval may be extended. The length of the paging listening interval may be defined as a multiple of superframe not 1 superframe (20 ms). At this time, the M value suggested in the present invention may be used as an element for the length of the paging listening interval. For example, the M value of the M field included in Table 5 may be 4, and it is assumed that the M value is 4 in FIG. 7. The paging listening interval of the M2M device corresponds to four superframes (4 superframes from paging offset), and the paging superframe monitored by the M2M device may be determined by M2M device ID modulo M. Also, for additional power saving of the M2M device, the paging frame may be determined within the paging superframe of the M2M device. In this case, the paging frame is determined by the N value included in the paging message that includes group paging indication.

If the group paging indication field is set to 0, to indicate the length of the paging listening interval of the M2M device as illustrated in Table 5, the paging message may include M field and N field which is the field related to transmission timing of the individual paging message to be transmitted to the M2M device. However, the M field may selectively be included in the paging message.

If the group paging indication field is set to 0, the processor 120 of the M2M device may acquire paging listening interval length information to be monitored by decoding the M field. Also, the processor 120 of the M2M device may perform M2M device ID modulo N operation by decoding the N field and receive the individual paging message at the time (for example, corresponding frame) generated from the result of the M2M device ID modulo N operation.

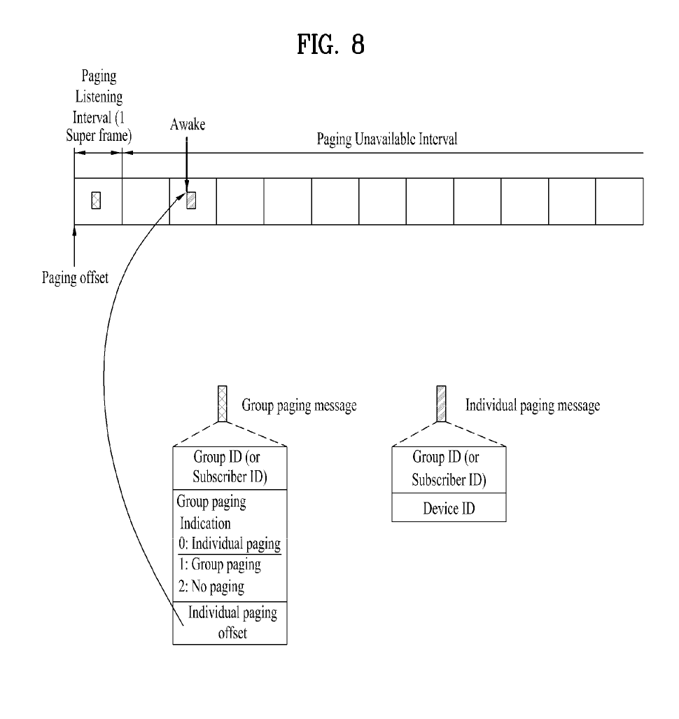

FIG. 8 is a diagram illustrating that an individual paging message is transmitted independently in accordance with another embodiment.

In FIG. 8, a group paging message, which includes a group paging indication field, includes an individual paging offset field to which the individual paging message is transmitted, wherein the individual paging message is preceded by the group paging message. Unlike FIG. 7, in the embodiment of FIG. 8, the paging listening interval of the M2M device is limited to 1 superframe (20 ms) in the same manner as the related art. As shown in FIG. 8, the M2M device may receive the paging message, which includes the group paging indication field, for the first frame (or the first subframe of the first frame) of its paging listening interval.

If the group paging indication field of the paging message is set to 0, the processor 120 of the M2M device may identify that individual paging is transmitted. If the group paging indication field is set to 0, the paging message may further include an individual paging offset field. In this case, the individual paging offset field is the field for indicating the time (frame or subframe) when the individual paging message of the M2M device is transmitted.

After acquiring the corresponding time indicated by the individual paging offset field by decoding the individual paging offset field, the processor 120 of the M2M device receives the individual paging message at the acquired corresponding time. At this time, the M2M device receives the individual paging message by waking up from the corresponding time (for example, corresponding frame or subframe time) even in case of a paging unavailable interval.

TABLE 6

| | Size | | |
|---|---|---|---|
| Fields | (bits) | Value/Description | Condition |
| . . . | | | |
| M2M Group (or | | Subscriber ID to which M2M device | |
| subscriber) | | belongs | |
| Multicast ID | | | |
| Group paging | | 0 = indicates that individual M2M | |
| indication | | devices belonging to group are paged | |
| | | If Group paging indication is set to 0, | |
| | | individual M2M devices are paged to | |
| | | their individual identifier (e.g., DID or | |
| | | MAC address or MAC address hash). | |
| | | 1 = indicates that all M2M devices | |
| | | belonging to group are paged | |
| | | 2 = indicates that all M2M devices | |
| | | belonging to group are not paged | |
| If (Group paging | | | |
| indication == 0) | | | |
| { | | | |
| Num_M2M_Devices | | Indicates the number of paged M2M | |
| | | devices in a corresponding M2M group | |
| For (i=0; | | | |
| i<Num_M2M_devices; | | | |
| i++) { | | | |
| Or MAC address hash | | Used to indicate ID for M2M device to | |
| of M2M device | | be paged | |
| Action code | | Used to indicate the purpose of the | |
| | | AAI_PAG-ADV message | |
| | | 0b0: perform network reentry | |
| | | 0b1: perform ranging for location | |
| | | update | |
| } | | | |
| } | | | |
| If (Group paging | | | |
| indication == 1) | | | |
| { | | | |
| // if (Group paging | | | |
| indication == 2) | | | |
| {parameters are not | | | |
| required as there is no | | | |
| M2M device paged}// | | | |

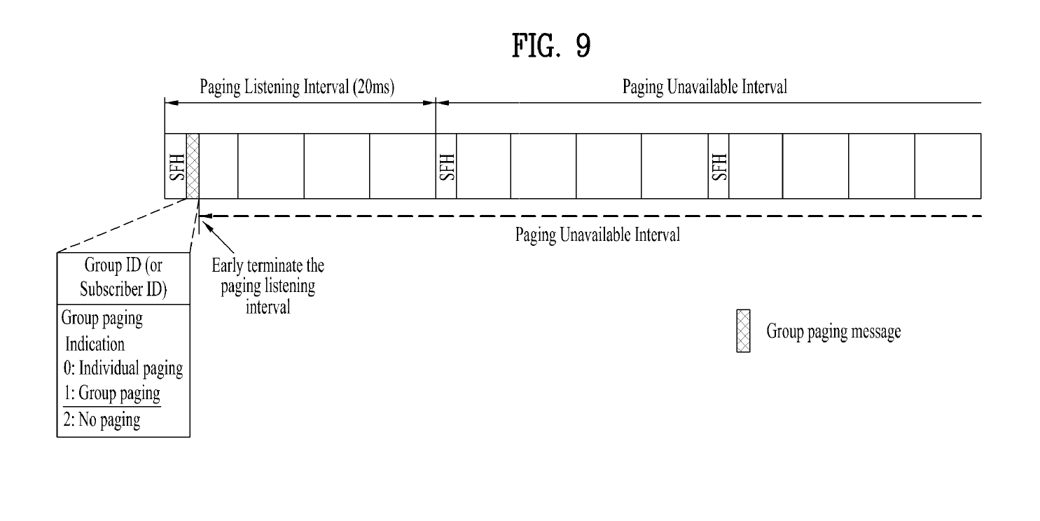

FIG. 9 is a diagram illustrating an example that there is no M2M device for paging in a group.

If the M2M device receives the paging message of which group paging indication field is set to 2 as illustrated in Table 6, the processor 120 of the M2M device that has identified the paging message ends the paging listening interval and starts the paging unavailable interval as shown in FIG. 9, whereby power consumption of the M2M device may be reduced.

Hereinafter, as another embodiment of the present invention, idle mode parameter update will be described. The present invention suggests a method for updating a parameter required by an M2M device to perform an idle mode operation, as follows.

### <Group Based Update>

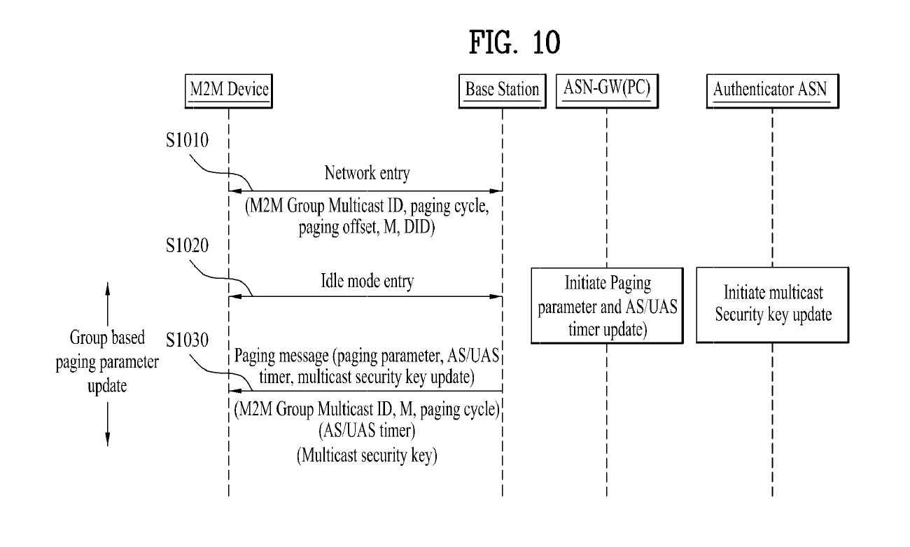

FIG. 10 is a diagram illustrating a method for allowing M2M devices, which belong to one group, to update a parameter.

Referring to FIG. 10, the M2M device may negotiate values, such as M2M group multicast ID (that is, M2M group ID), paging cycle, paging offset, M (value used to determine paging listening interval, paging superframe, and paging frame), deregistration ID (DID), available state (AS) timer, unavailable state (UAS) timer, with the base station during a capability negotiation procedure of network entry (S1010).

Afterwards, after entering the idle mode (S1020), the M2M device may receive the paging message from the base station (S1030). The paging message may include paging parameters of the M2M devices, a paging cycle, an action code field, an available state (AS) timer/unavailable state (UAS) timer field, an a multicast security key field. The M2M device may update the paging parameters included in the paging message. The base station may update the parameters in a unit of group by allowing M2M group ID to be included in the paging message. The following Table 7 illustrates parameters updated through the paging message. Access service network gateway (ASNGW) may update the paging parameters and the AS/NAS timer and transfer the updated results to the base station, and an authenticator ASN may update a multicast security key and transfer the updated information to the base station.

TABLE 7

| | Size | | |
|---|---|---|---|
| Fields | (bits) | Value/Description | Condition |
| . . . | | | |
| M2M Group (or | | Subscriber ID to which M2M device | |
| subscriber) | | belongs | |
| Multicast ID | | | |
| Action code | | 0: reentry from idle mode | |
| | | 1: ranging for location update | |
| | | 2: update of idle mode parameters | |
| If (action code == 2) | | | |
| { | | | |
| Paging cycle | | | |
| M | | Value used to determine paging | |
| | | listening interval length of M2M | |
| | | device. | |
| | | That is, paging listening interval of | |
| | | M2M device is as follows. | |
| | | Paging listening interval = M x | |
| | | superframe” | |
| | | Also, paging superframe monitored by | |
| | | M2M device is determined by modulo | |
| | | operation as follows. | |
| | | M2M device ID (for example, DID) | |
| | | modulo M” | |
| | | M value is also used to determine a | |
| | | standby time until random access | |
| | | procedure of M2M device is performed | |
| | | during uplink code ranging performed | |
| | | when M2M device performs network | |
| | | reentry by receiving paging message | |
| | | (see FIG. 6). | |
| M2M group (or | | Subscriber ID or M2M group ID to | |
| subscriber) Multicast | | which updated M2M device belongs | |
| ID | | | |
| Multicast security key | | Updated common security key used by | |
| | | M2M device within group | |
| Available state timer | | Time duration in which updated M2M | |
| | | device maintains available state | |
| Unavailable state timer | | Time duration in which updated M2M | |
| | | device maintains unavailable state | |
| } | | | |
| ~ | | | |

If the M2M device receives the paging message from the base station, the processor 120 of the M2M device may decode the action code field and identify that the paging message is intended to update an idle mode parameter if an action code field value is set to 2. If the action code field value is set to 2, the paging message may further include a paging cycle field, an M field, an M2M group (or subscriber) multicast ID field (that is, M2M group ID field), a multicast security key field, an available state timer field, and an unavailable state timer field. In this case, the M2M group ID field indicates a common security key used by the M2M device within the group. The available state timer field indicates time duration in which the M2M device maintains an available state, and the unavailable state timer field indicates time duration in which the M2M device maintains an unavailable state.

The processor 120 of the M2M device may acquire the updated M2M group ID, the multicast security key, the time duration information for maintaining the available state, and the time duration information for maintaining the unavailable state by decoding the updated M2M group ID field, the multicast security key field, the available state timer field, and the unavailable state timer field.

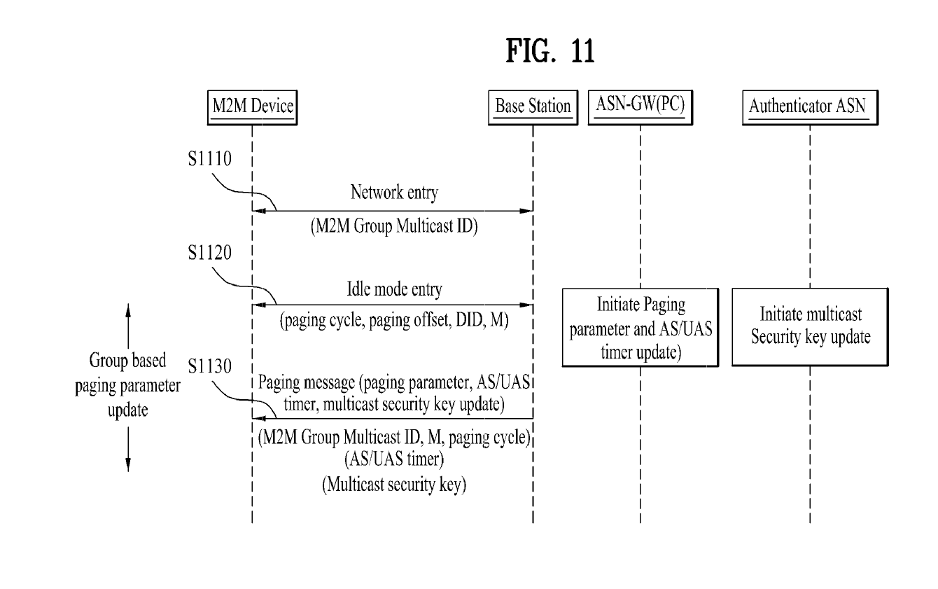

FIG. 11 is a diagram illustrating that an idle mode parameter is updated through a paging message and allocated to an M2M device during idle mode entry.

Referring to FIG. 11, in the same manner as FIG. 10, the M2M device may negotiate values, such as M2M group multicast ID (that is, M2M group ID), paging cycle, paging offset, M (value used to determine paging listening interval, paging superframe, and paging frame), deregistration ID (DID), available state (AS) timer, unavailable state (UAS) timer, with the base station during a capability negotiation procedure of network entry (S1110).

Afterwards, unlike FIG. 10, the paging cycle, the paging offset, the DID, and the M value may be allocated from the base station to the M2M device during the idle mode entry procedure (S1120). Afterwards, the procedure of allowing the M2M device to acquire the idle mode parameter through the paging message by receiving update information at step S1130 is the same as the step S1030 of FIG. 10.

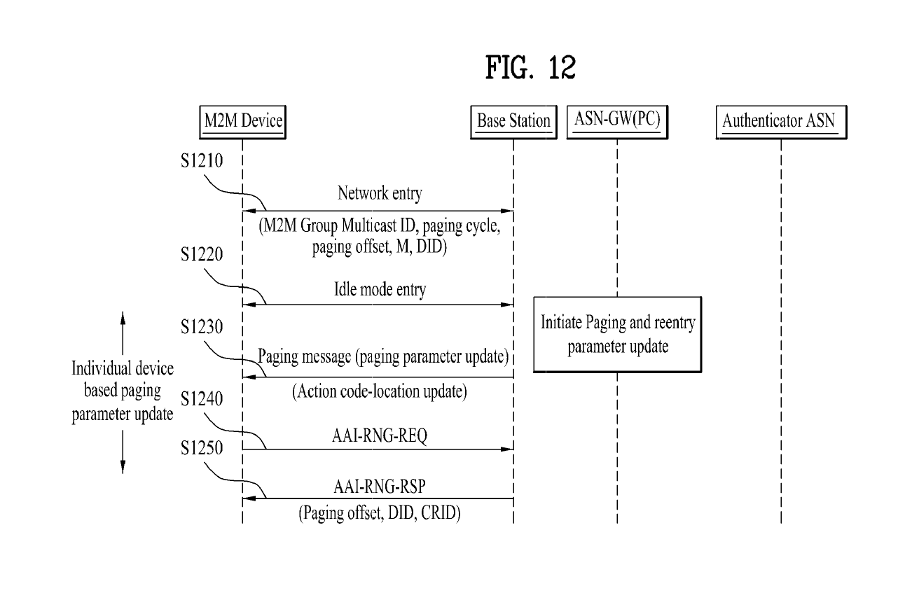

FIG. 12 is a diagram illustrating an embodiment that an idle mode parameter of each of individual M2M devices is updated through a unicast MAC control message.

Referring to FIG. 12, the M2M device may negotiate values, such as M2M group multicast ID (that is, M2M group ID), paging cycle, paging offset, M (value used to determine paging listening interval, paging superframe, and paging frame), deregistration ID (DID), available state (AS) timer, unavailable state (UAS) timer, with the base station during a capability negotiation procedure of network entry (S1210).

Afterwards, the M2M device enters the idle mode (S1220), and the network may request the M2M device of location update of the M2M device through the paging message if update of the paging parameters of the M2M devices, the AS/UAS timer, and the multicast security key is required (S1230).

The M2M device that has been requested locate update may transmit a ranging request message (for example, AAI-RNG-REQ message) to the base station (S1240), and may receive parameters updated through a ranging response message (for example, AAI-RNG-RSP message) from the base station in response to the ranging request message (S1250). At this time, the parameter updated through the individual unicast MAC message (for example, ranging response message) may be the parameter, which cannot be updated in a unit of group, such as DID, paging offset, and context retention Identifier (CRID).

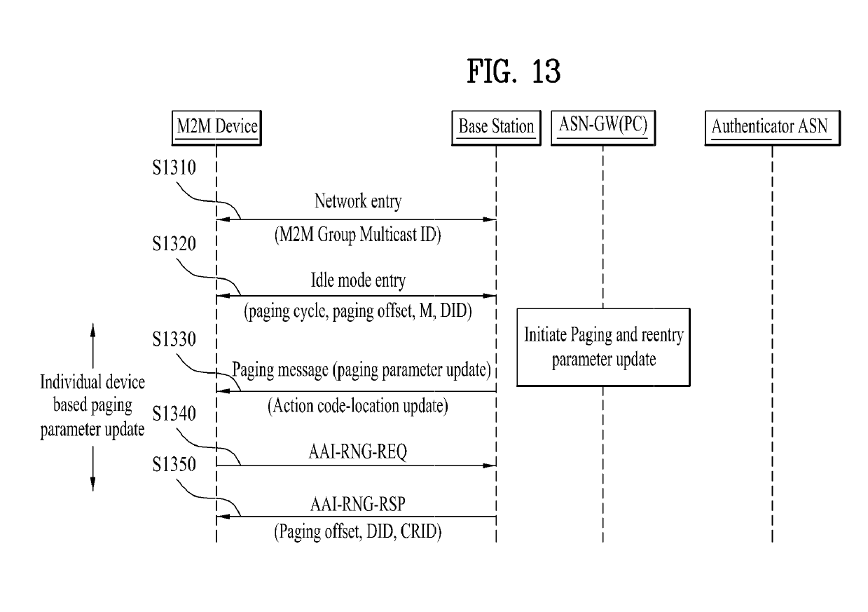

FIG. 13 is a diagram illustrating that an idle mode parameter is updated in the same manner as FIG. 12 and allocated to an M2M device during idle mode entry.

Referring to FIG. 13, the M2M device negotiates M2M group multicast ID (that is, M2M group ID) with the base station during a capability negotiation procedure of network entry (S1310). Afterwards, paging cycle, paging offset, M value (value used to determine paging listening interval, paging superframe, and paging frame), and DID may be allocated from the base station to the M2M device during the idle mode entry procedure (S1320). Afterwards, the base station may request the M2M device of location update of the M2M device through the paging message (S1330). The M2M device that has been requested locate update may transmit a ranging request message (for example, AAI-RNG-REQ message) to the base station (S1340), and may receive parameters updated through a ranging response message (for example, AAI-RNG-RSP message) from the base station in response to the ranging request message (S1350). At this time, the parameter updated through the ranging response message may be the parameter, which cannot be updated in a unit of group, such as DID, paging offset, and context retention Identifier (CRID).

Although the operation of the M2M device has been described in the aforementioned embodiments according to the present invention, it is to be understood that the embodiments of the present invention may be applied to a human type communication (HTC) device. Also, the respective fields included in the various paging message formats refer to the same thing but may be referred to as different things.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. It will be apparent that some claims referring to specific claims may be combined with another claims referring to the other claims other than the specific claims to constitute the embodiment or add new claims by means of amendment after the application is filed.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is also obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

The method for transmitting and receiving idle-mode parameter update information and an apparatus therefor may industrially be applicable to various communication systems such as 3GPP LTE system, LTE-A system and IEEE 802 system.

1-15. (canceled)

16. A method of performing an update of an updated parameter by a Machine to Machine (M2M) device in a wireless communication system, the method comprising:
receiving, a M2M group identifier (MGID) for the M2M device, from a base station;
receiving, a paging message for a triggering of the location update using the MGID, from the base station, wherein the paging message includes the MGID;
transmitting, a ranging request message including a ranging purpose, to the base station, wherein the ranging purpose indicates the location update; and
receiving, a ranging response message with a updated parameter from the base station, in response to the ranging request message.

17. The method of claim 16, further comprising:
performing the update of the updated parameter according to a ranging response message.

18. The method of claim 16, wherein the MGID is assigned to the M2M device belong to a same M2M group.

19. The method of claim 18, wherein the MGID is assigned by a capability negotiation during a network entry between the M2M device and the base station.

20. The method of claim 16, wherein the paging message corresponding to an Advanced Air Interface paging advertisement (AAI-PAG-ADV) message, the ranging request message corresponds to an Advanced Air Interface ranging request (AAI-RNG-REQ) message and the ranging response message corresponds to the Advanced Air Interface ranging response (AAI-RNG-RSP) message.

21. The method of claim 16, wherein the MGID is used to identify a multicast traffic.

22. The method of claim 16, wherein the paging message corresponds to a M2M group paging message.

23. The method of claim 16, wherein an action code is set to 0b01 in the paging message for the triggering of the location update.

24. A method of performing update of an updated parameter by a base station in a wireless communication system, the method comprising:
transmitting, a M2M group identifier (MGID) for a Machine to Machine (M2M) device, to the M2M device;
transmitting, a paging message for a triggering of the location update, to the M2M device, wherein the paging message includes the MGID;
receiving, a ranging request message including a ranging purpose, from the M2M device, wherein the ranging purpose indicates the location update; and
transmitting, a ranging response message with an updated parameter to the M2M device, in response to the ranging request message.

25. The method of claim 24, wherein the MGID is assigned to the M2M device belong to a same M2M group.

26. The method of claim 25, wherein the MGID is assigned by a capability negotiation during a network entry between the M2M device and the base station.

27. The method of claim 24, wherein the MGID is used to identify a multicast traffic.

28. The method of claim 24, wherein the paging message corresponds to a M2M group paging message.

29. The method of claim 24, wherein an action code is set to 0b01 in the paging message for the triggering of the location update.

30. A Machine to Machine (M2M) device for performing an update of an updated parameter in a wireless communication system, the M2M device comprising:
a receiver;
a transmitter; and
a processor,
wherein the processor is configured to control that the receiver receive a M2M group identifier (MGID) for the M2M device from a base station, the receiver receives, a paging message for a triggering of the location update using the MGID from the base station, wherein the paging message includes the MGID, the transmitter transmits a ranging request message including a ranging purpose to the base station, and the receiver receives, a ranging response message with an updated parameter from the base station, in response to the ranging request message, and
wherein the ranging purpose indicates the location update.

31. The M2M device of claim 30, wherein the processor is further configured to perform the update of the updated parameter according to the ranging response message.

32. A base station for performing an update of an updated parameter in a wireless communication system, the base station comprising:
a receiver;
a transmitter; and
a processor,
wherein the processor is configured to control that the transmitter transmits a M2M group identifier (MGID) for a Machine to Machine (M2M) device to the M2M device, the transmitter transmits a paging message for a triggering of the location update to the M2M device, wherein the paging message includes the MGID, the receiver receives a ranging request message including a ranging purpose from the M2M device, the transmitter transmits a ranging response message with a new MGID to the M2M device in response to the ranging request message, and
wherein the ranging purpose indicates the location update.
